(19) United States
(12) Patent Application Publication
(10) Pub. No.: US 2017/0242310 A1
(43) Pub. Date: Aug. 24, 2017

(54) LIQUID CRYSTAL DISPLAY DEVICE

(71) Applicant: Japan Display Inc., Minato-ku (JP)

(72) Inventor: Toshiharu MATSUSHIMA, Tokyo (JP)

(73) Assignee: Japan Display Inc., Minato-ku (JP)

(21) Appl. No.: 15/440,674

(22) Filed: Feb. 23, 2017

(30) Foreign Application Priority Data
Feb. 23, 2016 (JP) 2016-032154

(51) Int. Cl. G02F 1/1343; G02F 1/1335; G02F 1/1362

(52) U.S. Cl. CPC G02F 1/134363; G02F 1/136286; G02F 1/133514; G02F 2201/123; G02F 2201/121; G02F 2001/134345; G02F 2001/136218; G02F 2001/134372

(57) ABSTRACT

According to one embodiment, a liquid crystal display device comprises a liquid crystal and first and second substrates. The first substrate comprises pixel electrodes, a common electrode and sub-pixel areas. The sub-pixel areas each have a first area in which the pixel electrodes is provided and the second area in which the pixel electrode is not provided. The sub-pixel areas include first and second sub-pixel areas. A shortest distance between the first area of the each first sub-pixel area and the first area of the associated second sub-pixel area is 5 μm or less. When an image is displayed, a polarities of the pixel electrodes in the first and second sub-pixel areas are different from each other.

### CROSS-REFERENCE TO RELATED APPLICATIONS

This application is based upon and claims the benefit of priority from Japanese Patent Application No. 2016-032154, filed Feb. 23, 2016, the entire contents of which are incorporated herein by reference.

### FIELD

Embodiments described herein relate generally to a liquid crystal display device.

### BACKGROUND

An in-plane-switching (IPS) mode type of liquid crystal display device is known as an example of a display device. In the IPS mode type of liquid crystal display device, pixel electrodes and a common electrodes are provided in one of a pair of substrates which are located opposite to each other, with a liquid crystal layer interposed between them, and alignment of liquid crystal molecules in the liquid crystal layer is controlled using a lateral electric field produced between each of the pixel electrodes and the common electrode. Furthermore, a fringe field switching (FFS) mode type of liquid crystal display device is put to practical use. In the FFS mode type of liquid crystal display device, the pixel electrodes and the common electrode are provided in different layers, and alignment of liquid crystal molecules is controlled using a fringe field produced between each of the pixel electrodes and the common electrode.

Also, a liquid crystal display device is known in which pixel electrodes and a common electrode are provided in different layers, and slits are provided in either the common electrode or the pixel electrodes, which is/are closer to a liquid crystal layer, and liquid crystal molecules present in the vicinity of one of the both sides of each of the slits in the width direction thereof are rotated in an opposite direction to the rotational direction of liquid crystal molecules present in the vicinity of the other side. The mode of this type of liquid crystal display device is clearly different from the FFS mode, and can increase a response speed and improve stability of alignment of liquid crystal molecules, as compared with the FFS mode. In the following, the mode of such a type of liquid crystal display device is referred to as a high-speed response mode.

A liquid crystal display device adopting the high-speed response mode can have an area in which alignment of liquid crystal molecules becomes unstable because of interactions between electric fields produced in the vicinity of adjacent pixel electrodes. Such an area causes lowering of the display quality of the liquid crystal display device.

### BRIEF DESCRIPTION OF THE DRAWINGS

FIG. 1 is a perspective view schematically illustrating a configuration of a liquid crystal display device according to a first embodiment.

FIG. 2 is a view schematically illustrating an equivalent circuit in the liquid crystal display device.

FIG. 3 is a view illustrating part of a cross section of the liquid crystal display device.

FIG. 4 is a plan view schematically illustrating a sub-pixel included in the liquid crystal display device.

FIG. 5 is a view illustrating an initial alignment state of liquid crystal molecules in the liquid crystal display device.

FIG. 6 is a view illustrating an alignment state of liquid crystal molecules on which electric fields act.

FIG. 7 is a view illustrating equipotential lines in the vicinity of the boundary between pixel electrodes to which voltages having the same polarity are applied.

FIG. 8 is a plan view illustrating an example of arrangement of first electrodes included in sub-pixels.

FIG. 9 is a view illustrating equipotential lines in the vicinity of the boundary between pixel electrodes to which voltages having different polarities are applied.

FIG. 10 is a plan view schematically illustrating a light-shielding layer included in the liquid crystal display device.

FIG. 11 is a plan view illustrating an example of arrangement of sub-pixels in a second embodiment.

FIG. 12 is a plan view illustrating an example of arrangement of sub-pixels in a third embodiment.

FIG. 13 is a view illustrating part of a configuration of a liquid crystal display device according to a fourth embodiment.

FIG. 14 is a plan view schematically illustrating a configuration of part of a second sub-pixel included in the liquid crystal display device, which is located in the vicinity of a slit.

FIG. 15 is a plan view schematically illustrating a configuration of the vicinity of a slit in a liquid crystal display device according to a fifth embodiment.

FIG. 16 is a schematic cross-sectional view taken along line XVI-XVI in FIG. 15.

FIG. 17 is a view illustrating part of a cross section of the liquid crystal display device according to a sixth embodiment.

FIG. 18 is a plan view schematically illustrating a first electrode included in the liquid crystal display device.

FIG. 19 is a view illustrating an example of application of the same method as described with reference to FIG. 8 to the sixth embodiment.

### DETAILED DESCRIPTION

In general, according to one embodiment, a liquid crystal display device comprises a liquid crystal layer including liquid crystal molecules between a first substrate and a second substrate facing the first substrate. The first substrate comprises a plurality of image signal lines, a plurality of scanning signal lines crossing the image signal lines, pixel electrodes electrically connected to the image signal lines, a common electrode configured to cause an electric field with the pixel electrodes to rotate the liquid crystal molecules, and a plurality of sub-pixel areas. The sub-pixel areas each have a first area and a second area in plan view. The first area is an area in which an associated one of the pixel electrodes is provided, and the second area is an area in which the associated pixel electrode is not provided. The first area includes a connection area extending in a first direction and a plurality of branch areas extending from the connection area in a second direction crossing the first direction. The branch areas each include a first side and a second side in a width direction, and when the electric field is generated, liquid crystal molecules present in vicinity of the first side and liquid crystal molecules present in vicinity of the second side are rotated in different rotational directions. The sub-pixel areas include first sub-pixel areas and second sub-pixel areas, and each of the first sub-pixel areas are adjacent to an associated one of the second sub-pixel areas, with an associated one of the image signal lines or the scanning signal lines interposed between the each first sub-pixel area and the associated second sub-pixel area. A shortest distance between the first area of the each first sub-pixel area and the first area of the associated second sub-pixel area is 5 μm or less. When an image is displayed, a polarity of the pixel electrodes in the first sub-pixel areas is different from a polarity of the pixel electrodes in the second sub-pixel areas.

According to another embodiment, the second area may be an area in which the common electrode is provided, and the first area may be an area in which the common electrode is not provided.

For example, by virtue of structural features described below, it is possible to provide a high-speed response mode type of liquid crystal display device which can improve a display quality.

Embodiments will be described with reference to the accompanying drawings.

The disclosure is a mere example, and proper change of gist which can be easily conceived by a person of ordinary skill in the art naturally falls within the inventive scope. In addition, in some cases, in order to make the description clearer, the drawings may be more schematic than in the actual modes, but they are mere examples, and do not limit the interpretation of the present invention. Also, in some cases, in each of the drawings, reference numbers of identical or similar elements successively disposed are omitted. In the specification and drawings, after structural elements are each explained once with reference to any of the drawings, there is a case where their explanations will be omitted as appropriate, and those identical to or similar to the explained structural elements will be denoted by the same reference numbers, respectively, as the explained structural elements.

With respect to each of the embodiments, a transmissive liquid crystal display device will be described as an example of a liquid crystal display device. However, each of the embodiments does not preclude the application of individual technical ideas disclosed regarding the embodiments to other kinds of display devices. For example, a reflective liquid crystal display device which displays an image using external light and a transflective liquid crystal display device having both functions of the reflective liquid crystal display device and a transmissive liquid crystal display device can be considered as the above other kinds of liquid crystal display devices.

### First Embodiment

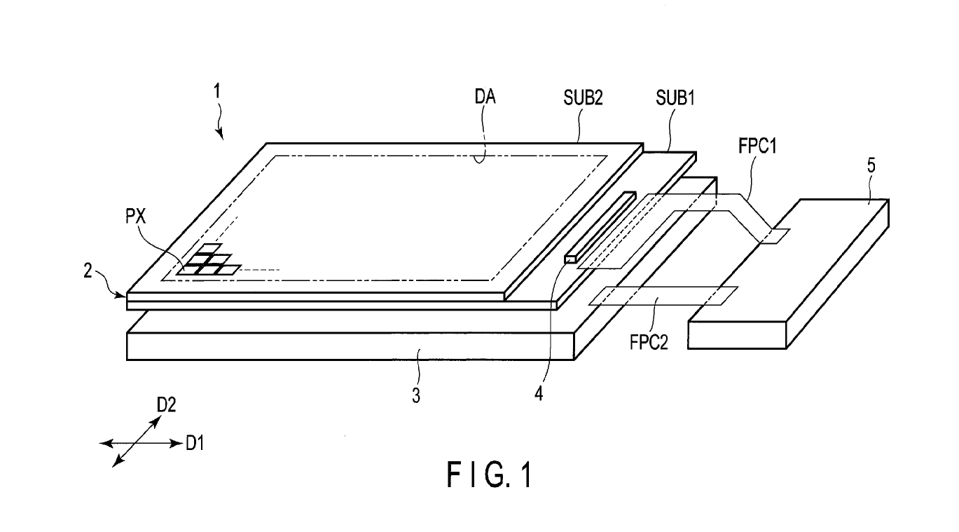

FIG. 1 is a perspective view of a liquid crystal display device 1 according to the first embodiment. The liquid crystal display device 1 can be used in various devices such as a smartphone, a tablet device, a cell phone, a personal computer, a television receiver, a vehicle mounted device, a games console and a wearable terminal.

The liquid crystal display device 1 comprises a display panel 2, a backlight 3 located opposite to the display panel 2, a driver 104 which drives the display panel 2, a control module 5 which controls operations of the display panel 2 and the backlight 3, flexible circuit boards FPC1 and FPC2 which transmit control signals to the display panel 2 and the backlight 3.

With respect to the first embodiment, a first direction D1 and a second direction D2 are defined as shown in FIG. 1. The first direction D1 is, for example, a direction along long sides of the display panel 2. The second direction D2 is, for example, a direction along short sides of the display panel 2. In the example illustrated in FIG. 1, the directions D1 and D2 are perpendicular to each other; however, they may cross each other at an angle other than a right angle.

The display panel 2 comprises a first substrate SUB1, a second substrate SUB2 and a liquid crystal layer (hereinafter referred to as the liquid crystal layer LC) interposed between the first substrate SUB1 and the second substrate SUB2, the first substrate SUB1 and the second substrate SUB2 being located opposite to each other. The display panel 2 includes a display area DA which displays an image. The display panel 2, for example, in the display area DA, includes a plurality of pixels PX arranged in a matrix in the directions D1 and D2.

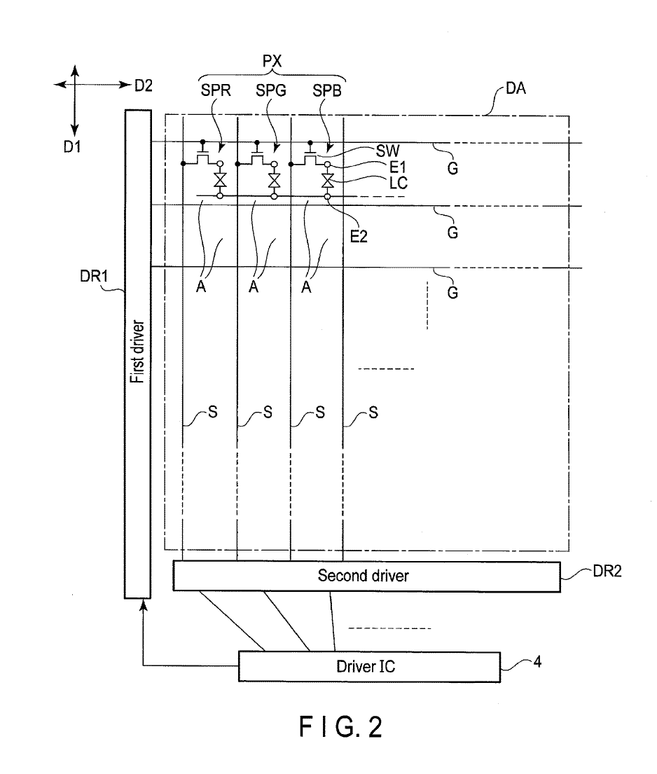

FIG. 2 is a view schematically illustrating an equivalent circuit in the liquid crystal display device 1. The liquid crystal display device 1 includes a first driver DR1, a second driver D2, a plurality of scanning signal lines G connected to the first driver DR1, and a plurality of image signal lines S connected to the second driver DR2. The scanning signal lines G, in the display area DA, extend in the second direction D2, and are arranged in the first direction D1. The image signal lines S, in the display area DA, extend in the first direction D1, are arranged in the second direction D2, and cross the scanning signal lines G.

The liquid crystal display device 1 includes a plurality of sub-pixel areas A. As seen in plan view, the sub-pixel areas A are areas defined by the scanning signal lines G and the image signal lines S. In the sub-pixel areas A, sub-pixels SP are provided. In the first embodiment, it is assumed that each pixel PX includes a red sub-pixel SPR, a green sub-pixel SPG and a blue sub-pixel SPB. However, each pixel PX may further include a white sub-pixel SPX or the like. Alternatively, each pixel PX may include a plurality of sub-pixels for the same color.

The sub-pixels SP respectively comprise switching elements SW, first electrodes E1 and the second electrode E2 which are located opposite to the first electrodes E1. The first electrodes E1 are formed in a first layer of the first substrate SUB1, and the second electrode E2 is formed in a second layer of the first substrate SUB1. In the first embodiment, the first electrodes E1 are pixel electrodes, and are provided along with the switching elements SW in the sub-pixels, respectively. Also, in the first embodiment, the second electrode E2 is a common electrode, and formed in the plurality of sub-pixels SP. The switching elements SW are electrically connected to the scanning signal lines G, the image signal lines S and the first electrodes E1.

The first driver DR1 successively supplies the scanning signal lines G with a scanning signal. The second driver DR2 selectively supplies the image signal lines S with an image signal. For example, when a scanning signal is supplied to a scanning signal line G connected to a given switching element SW, and an image signal is supplied to an image signal line G connected to the switching element SW, a voltage corresponding to the image signal is applied to an associated first electrode E1. At this time, because of an electric field produced between the associated first electrode E1 and the second electrode E2, an alignment state of liquid crystal molecules of the liquid crystal layer LC changes from an initial alignment state in which is an alignment state of the liquid crystal molecules in the case where no voltage is applied. By virtue of the above operation, an image is displayed in the display area DA.

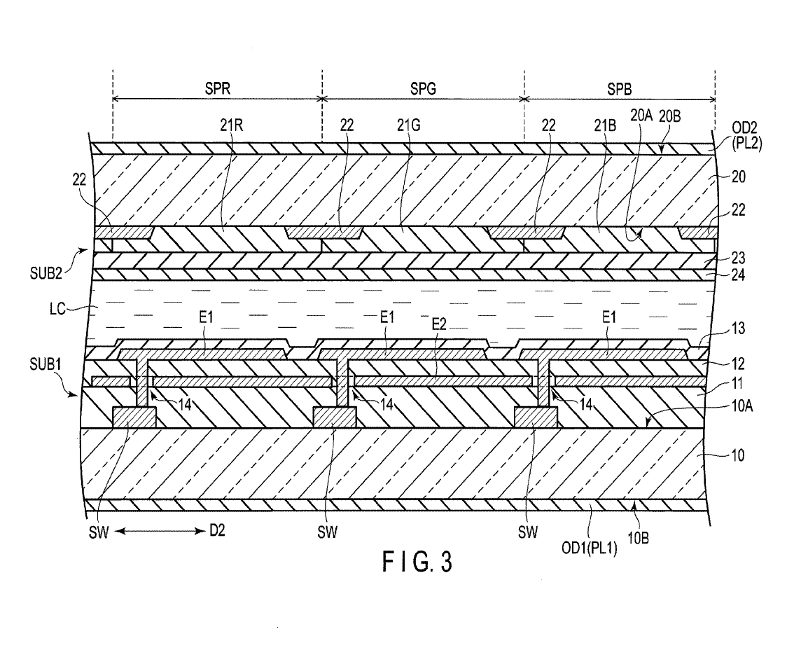

FIG. 3 is a view illustrating part of a cross section of the liquid crystal display device 1. To be more specific, FIG. 3 illustrates a cross section of each of sub-pixels SPR, SPG and SPB included in each pixel PX, which is taken in the second direction D2.

The first substrate SUB1 includes a first insulating substrate 10 such as a light transmissive glass substrate or resin substrate. The first insulating substrate 10 includes a first main surface 10A which faces the second substrate SUB2 and a second main surface 10B which is located on the opposite side of the first main surface 10A. Furthermore, the first substrate SUB1 comprises the switching elements SW, the first electrodes E1, the second electrode E2, a first insulating layer 11, a second insulating layer 12 and a first alignment film 13.

The switching elements SW are provided on the first main surface 10A of the first insulating substrate 10, and covered by the first insulating layer 11. It should be noted that in FIG. 3, the scanning signal lines G and the image signal lines S are omitted. Also, in FIG. 3, the switching elements SW are simplified. Actually, the first insulating layer 11 includes a plurality of layers, and the switching elements SW include semiconductor layers and a plurality of kinds of electrodes, which are formed in the layers included in the first insulating layer 11.

In the example illustrated in FIG. 3, the sub-pixels SPR, SPG and SPB include respective first electrodes E1, and the second electrode E2 is provided in the sub-pixels SPR, SPG and SPB. The second electrode E2 is provided on the first insulating layer 11 (the above second layer). The second electrode E2 includes opening portions 14 which are located opposite to the first electrodes E1, respectively. The second electrode E2 is covered by the second insulating layer 12.

The first electrodes E1 are formed on the second insulating layer 12 (the above first layer) and opposite to the second electrode E2. The first electrodes E1 are electrically connected to the switching elements SW of the sub-pixels SPR, SPG and SPB through the opening portions 14. The first electrodes E1 and the second electrode E2 are formed of a transparent conductive material such as indium tin oxide (ITO). The first alignment film 13 covers the first electrodes E1 and contacts the liquid crystal layer LC. The first alignment film 13 is subjected to an alignment treatment such as a rubbing treatment or an optical alignment treatment.

The second substrate SUB2 includes a second insulating substrate 20 such as a light transmissive glass substrate or a light transmissive resin substrate. The second insulating substrate 20 includes a first main surface 20A which faces the first substrate SUB1 and a second main surface 20B which is located on the opposite side of the first main surface 20A. Furthermore, the second substrate SUB2 comprises color filters 21 (21R, 21G and 21B), a light shielding layer 22, an overcoat layer 23 and a second alignment film 24. The second alignment film 24, as well as the first alignment film 13, is subjected to an alignment treatment such as a rubbing treatment or an optical alignment.

The light shielding layer 22, as seen in plan view, is located at boundaries between the sub-pixels SPR, SPG and SPB. The overcoat layer 23 covers the color filters 21R, 21G and 21B such that a surface of the overcoat layer 23 covering these color filters is flat. The second alignment film 24 covers the overcoat layer 23 and contacts the liquid crystal layer LC.

On the second main surface 10B of the first insulating substrate 10, a first optical element OD1 including a first polarizer PL1 is provided. On the second main surface 20B of the second insulating substrate 20, a second optical element OD2 including a second polarizer PL2 is provided.

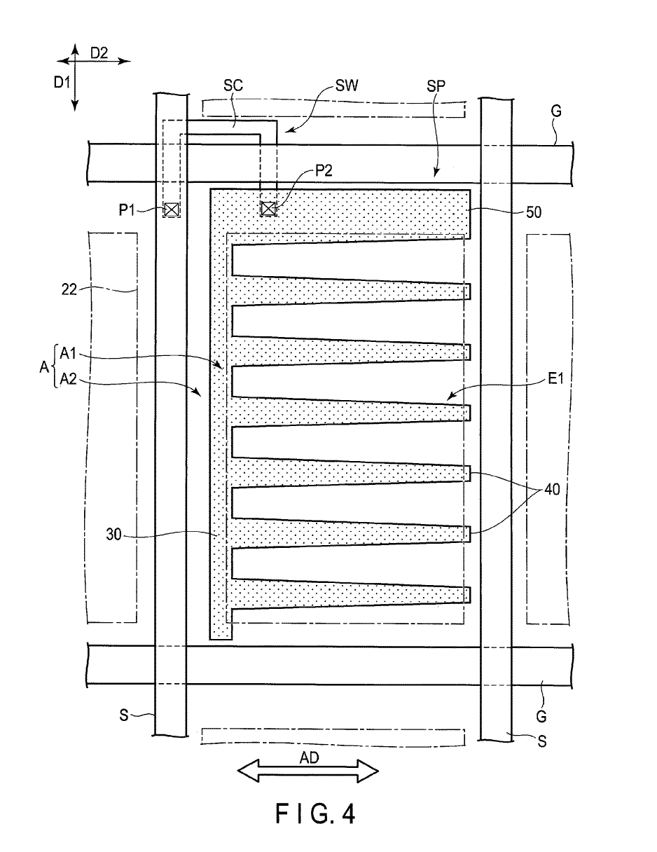

FIG. 4 is a plan view schematically illustrating an example of a sub-pixel SP. Two scanning signal lines G adjacent to each other in the first direction D1 and two image signal lines S adjacent to each other in the second direction D2 define a sub-pixel area A as described above. The sub-pixel area A includes a first area A1 and a second area A2. These areas A1 and A2 are both included in the first layer. In FIG. 4, the first area A1 is marked with dots. The second area A2 is a remaining area of the sub-pixel area A which is other than the first area A1.

The first area A1 includes an elongated connection area 30 extending in the first direction D1 and a plurality of branch areas 40 extending from the connection area 30. For example, the branch areas 40 are tapered toward their distal ends. In the example illustrated in FIG. 4, the branch areas 40 extend from the connection area 30 in the second direction D2.

Also, in the example illustrated in FIG. 4, the first area A1 includes an end area 50. The end area 50, as well as the branch areas 40, extend from the connection area 30 in the second direction D2. In the first direction D1, the end area 50 has a greater width than that of each of the branch areas 40.

One of the first area A1 and the second area A2 is an area in which a first electrode E1 is provided, and the other is an area in which the first electrode E1 is not provided. In the example illustrated in FIG. 4, in the first area A1, the first electrode E1 is provided, and in the second area A2, the first electrode E1 is not provided.

In the sub-pixel SP, the switching element SW includes a semiconductor layer SC. The semiconductor layer SC is connected to an image signal line S at a connection position P1, and connected to the first electrode E1 at a connection position P2. In the example illustrated in FIG. 4, the connection position P2 is located in the end area 50. The semiconductor layer SC twice crosses the upper one of the two scanning signal lines G as illustrated in FIG. 4. That is, in the example illustrated in FIG. 4, the switching element SW is of a double-gate type. However, the switching element SW may be a single-gate type of switching element SW which crosses the scanning signal line G only once.

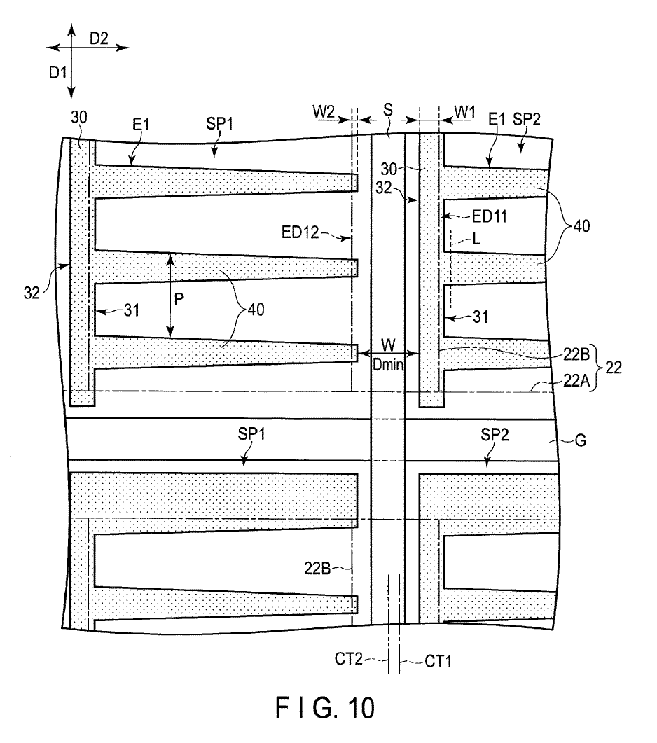

In FIG. 4, an edge portion of the light shielding layer 22 is indicated by a one-dot-chained line. The light shielding layer 22 overlaps with the scanning signal lines G, the image signal lines S and the switching elements SW. Furthermore, in the example illustrated in FIG. 4, the light shielding layer 22 overlaps with the connection area 30 and also the distal ends of the branch areas 40. The light shielding layer 22 will be described later in detail with reference to FIG. 10.

The first alignment film 13 and the second alignment film 24 as illustrated in FIG. 3 are subjected to an alignment treatment in an alignment treatment direction AD parallel to the second direction D2. Thereby, the first alignment film 13 and the second alignment film 24 have a function of aligning liquid crystal molecules in an initial alignment direction parallel to the alignment treatment direction AD. To be more specific, in the first embodiment, the extension direction of each of the branch areas 40 is the same as the initial alignment direction of the liquid crystal molecules.

In such a structure, it is possible to achieve a high-speed response mode whose response speed is higher than that of an FFS mode which is widely used. It should be noted that the response speed can be defined as a speed at which the light transmittance of the liquid crystal layer LC varies within a predetermined range by applying a voltage between, for example, the first electrode E1 and the second electrode E2.

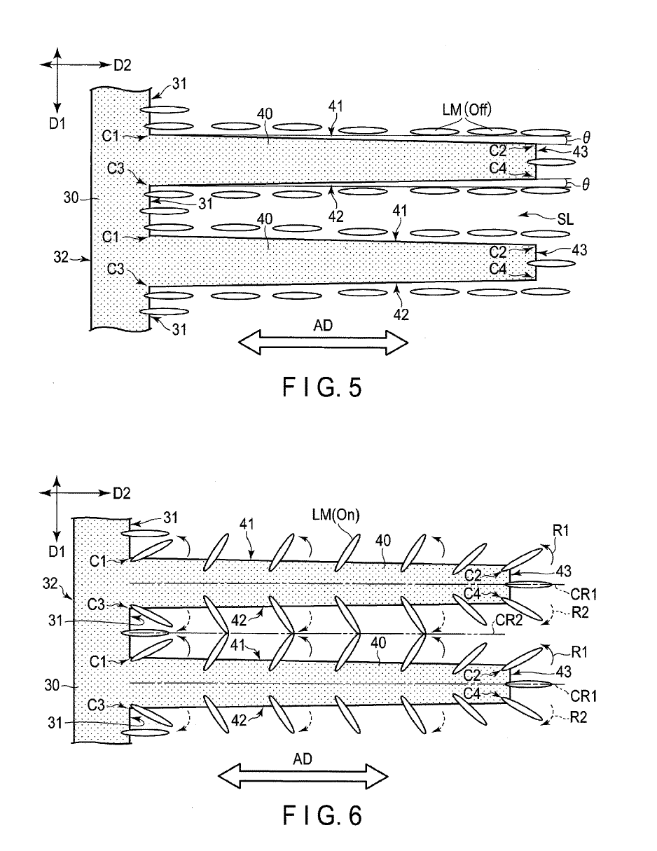

A principle of operation of the high-speed response mode will be explained with reference to FIGS. 5 and 6.

FIG. 5 is a view illustrating part of the second electrode E1 (the first area A1) and an initial alignment state of liquid crystal molecules LM contained in the liquid crystal layer LQ. Each of the branch areas 40 has a first side 41 and a second side 42 which are located on opposite sides in a width direction of the above each branch 40 (which is the same as the first direction D1). Furthermore, each branch area 40 includes a distal side 43 at its distal end, which is continuous with the first side 41 and the second side 42. The first side 41 is inclined at an angle θ (for example, approximately 1.0°) in a clockwise direction with respect to the alignment treatment direction AD, and the second side 42 is inclined at the angle θ in a counterclockwise direction with respect to the alignment treatment direction AD.

Between any adjacent two of the branch areas 40, for example, between two adjacent branch areas 40 as illustrated in FIG. 5, the connection area 30 includes a bottom side 31. Furthermore, in the connection area 30, on the opposite side of the bottom side 31, a lateral side 32 is provided. Also, between the two adjacent branch areas 40, a slit SL is provided in such a way as to be surrounded by the first side 41, the second side 42 and the bottom side 31. The slit SL is part of the second area A2.

A corner C1 is a corner at which the bottom side 31 and the first side 41 meet; a corner C2 is a corner at which the first side 41 and the distal side 43 meet; a corner C3 is a corner at which the bottom side 31 and the second side 42 meet; and a corner C4 is a corner at which the second side 42 and the distal side 43 meet.

In an off state in which a voltage is not applied between the first electrode E1 and the second electrode E2, the liquid crystal molecules are initially aligned such that their long axes are parallel to the alignment treatment direction AD as illustrated in FIG. 5.

In the FFS mode widely used, in the case where a fringing field is produced between two electrodes, the liquid crystal molecules are all rotated in the same direction. However, the rotation of the liquid crystal molecules in a liquid crystal mode adopted in the embodiments is different from that of the liquid crystal molecules in the FFS mode. FIG. 6 is a view illustrating an alignment state of liquid crystal molecules LM which is in an on state. In the first embodiment, the liquid crystal molecules LM have a positive dielectric anisotropy. Thus, in the off state as illustrated in FIG. 5, when a voltage is applied between the first electrode E1 and the second electrode E2, liquid crystal molecules LM are rotated such that their long axes are parallel to an electric field produced by the application of the above voltage (or they are perpendicular to equipotential lines).

In the vicinity of the corners C1 and C2, liquid crystal molecules LM are rotated in a first rotational direction R1 indicated by solid arrows. Furthermore, in the vicinity of corners C3 and C4, liquid crystal molecules LM are rotated in a second rotational direction R2 indicated by dashed arrows. The first rotational direction R1 and the second rotational direction R2 are different directions (opposite rotational directions).

The corners C1 to C4 have an alignment control function of controlling the rotational direction of liquid crystal molecules LM present in the vicinity of the first side 41 and the second side 42 (that is, they have a function of stabilizing the alignment of the liquid crystal molecules LM). To be more specific, the liquid crystal molecules LM located in the vicinity of the first side 41 are rotated in the first rotational direction R1 since they are influenced by the rotation of the liquid crystal molecules LM located in the vicinity of the corners C1 and C2. Also, the liquid crystal molecules LM present in the vicinity of the second side 42 are rotated in the second rotational direction R2 since they are influenced by the rotation of the liquid crystal molecules LM present in the vicinity of the corners C3 and C4. By contrast, in the vicinity of centers CR1 of the branch areas 40 in the first direction D1 and in the vicinity of centers CR2 of slits SL in the first direction D1, the number of liquid molecules LM rotated in the first rotational direction R1 is substantially the same as that of liquid crystal molecules rotated in the second rotational direction R2. Therefore, the liquid crystal molecules LM present in such areas are kept in their initial alignment state, and hardly rotated.

In such a manner, in the high-speed response mode, in the vicinity of the first side 41, liquid crystal molecules LM present in the range from the bottom side 31 to the distal side 43 are rotated in the same direction, and in the vicinity of the second side 42, liquid crystal molecules LM located in the range from the bottom side 31 to the distal side 43 are also rotated in the same direction. It is therefore possible to increase the response speed at the time of applying a voltage, and also reduce rotation of liquid crystal molecules LM in different directions, which are located in the vicinity of each of the above sides, thus improving the stability of alignment of the liquid crystal molecules.

It should be noted that in each of the branch areas 40 as illustrated in FIGS. 5 and 6, the first side 41 and the second side 42 are inclined with respect to the alignment treatment direction AD. This feature also contributes to improvement of the alignment stability. To be more specific, in the vicinity of the first side 41 and second side 42 inclined with respect to the alignment treatment direction AD, an electric field crosses the alignment treatment direction AD at an angle other than a right angle, whereby the liquid crystal molecules LM present in the vicinity of each of the above sides can be rotated in substantially the same direction.

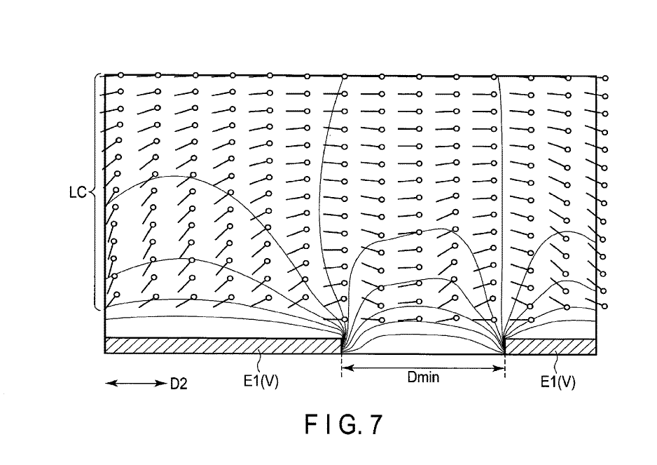

In the liquid crystal display device 1 adopting such a high-speed response mode as described above, in order to stabilize the alignment of the liquid crystal display molecules, it is necessary to appropriately design not only elements provided in the sub-pixel areas A, but a relationship between adjacent sub-pixels SP. FIG. 7 is a view illustrating an example of equipotential lines of an electric field which is present in the vicinity of the boundary between pixel electrodes of adjacent sub-pixels SP (which correspond to first electrodes E1 in the first embodiment).

Referring to FIG. 7, for example, voltages V having the same polarity are applied to two first electrodes E1. Because of the voltages V, an electric field is produced between the first electrodes E1 and the second electrodes E2, which are located below the first electrodes E1.

As can be seen from the equipotential lines illustrated in FIG. 7, when voltages V having the same polarity are applied to adjacent first electrodes E1, an electric field which reaches the liquid crystal layer LC is weak. Thus, an alignment state of liquid crystal molecules present in the vicinity of the boundary between the adjacent first electrodes E1 becomes unstable.

In the first embodiment, the shortest distance Dmin between the adjacent first electrodes E1 is, for example, 5 μm or less. In such a case, in the case where elements of sub-pixels SP are arranged at a higher density, since the distances between the first electrodes E1 are short, alignment of liquid crystal molecules present in the vicinity of the boundaries between the first electrodes E1 can further become unstable.

A structure for stabilizing alignment of the liquid crystal molecules present in the vicinity of the boundaries between the first electrodes E1 will be explained.

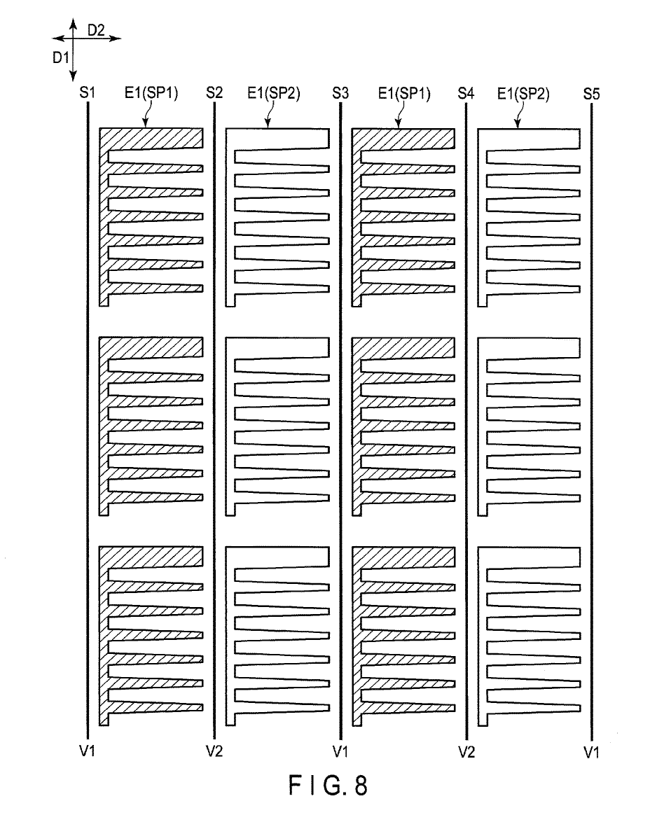

FIG. 8 is a plan view illustrating an example of arrangement of first electrodes E1. To be more specific, FIG. 8 illustrates first electrodes E1 of sub-pixels SP arranged between five image signal lines S. In the following, the five image signal lines S as illustrated in FIG. 8 are referred to as a first image signal line S1, a second image signal line S2, a third image signal line S3, a fourth image signal line S4 and a fifth image signal line S5 in left-to-right order.

The sub-pixels SP arranged in the display area DA include first sub-pixels (first sub-pixel areas) SP1 and second sub-pixels (second sub-pixel areas) SP2. In FIG. 8, in order to distinguish the first sub-pixels SP1 and the second sub-pixels SP2 from each other, the first sub-pixels SP1 are hatched.

In the example illustrated in FIG. 8, sub-pixels SP located between the image signal lines S1 and S2 and sub-pixels SP located between the image signal lines S3 and S4 are all first sub-pixels SP1. By contrast, sub-pixels SP located between the image signal lines S2 and S3 and sub-pixels SP located between the image signal lines S4 and S5 are all second sub-pixels SP2.

Also, in the entire display area DA, a plurality of columns of first sub-pixels SP1 arranged in the first direction D1 and a plurality of columns of second sub-pixels SP2 arranged in the first direction D1 are alternately arranged the second direction D2. Each of columns of sub-pixels is a column of sub-pixels which are located between associated adjacent image signal lines S and arranged in the first direction D1.

The second driver DR2 as illustrated in FIG. 2 applies a first voltage V1 to the image signal lines S1, S3 and S5. Also, the second driver DR2 applies a second voltage V2 to the image signal lines S2 and S4. The first voltage V1 is an image signal corresponding to a voltage (having a positive polarity) higher than a common voltage to be applied to the second electrode E2. The second voltage V2 is an image signal (having a negative polarity) corresponding to a voltage lower than the common voltage. The value of each of the voltages V1 and V2 is determined in units of one frame and in units of one sub-pixel SP such that the difference between each of the voltages and the common voltage is a value determined in accordance with the display color of an associated sub-pixel.

The first voltage V1 applied to the image signal lines S1 and S3 is applied to the first electrodes E1 of first sub-pixels SP1 arranged between the image signal lines S1 and S2 and between the image signal lines S3 and S4. The second voltage V2 applied to the image signal lines S2 and S4 is applied to the second electrodes E1 which are included in second sub-pixels SP2 arranged between the image signal lines S2 and S3 and between the image signal lines S4 and S5. That is, the first sub-pixels SP1 are sub-pixels SP to which the first voltage V1 is to be applied, and the second sub-pixels SP2 are sub-pixels SP to which the second voltage V2 is to be applied.

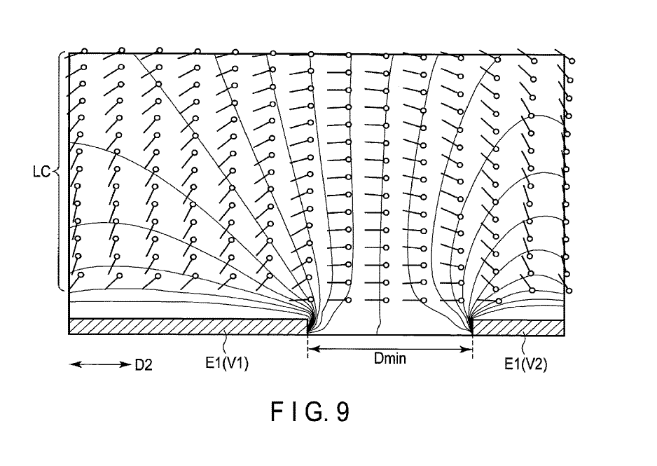

In such a manner, in the example illustrated in FIG. 8, in the case where an image or images are displayed, voltages applied to first electrodes E1 adjacent to each other in the second direction D2 have different polarities. FIG. 9 illustrates an example of equipotential lines of an electric field produced in the vicinity of the boundary between the two first electrodes E1 in the above case. Referring to FIG. 9, the first voltage V1 having a positive polarity is applied to the left one of the two first electrodes E1, and the second voltage V2 having a negative polarity is applied to the right one of the two first electrodes E1.

In the example illustrated in FIG. 7, voltages V having the same polarity are applied to the adjacent first electrodes E1. Thus, the potentials of the first electrodes E1 are not different from each other, or even if they are different from each other, the difference is small. By contrast, in the example illustrated in FIG. 9, voltages V1 and V2 having opposite polarities are applied to the adjacent first electrodes E1, as a result of which the potentials of the first electrodes E1 greatly differ from other. Thus, the equipotential lines between these first electrodes E1 become closer to each other, and an electric field satisfactorily acts on the liquid crystal layer LC. Thereby, even in the case where the shortest distance Dmin between the adjacent first electrodes E1 is 5 μm or less, alignment of the liquid crystal molecules present in the boundary between the first electrodes E1 becomes stable, and the display quality of the liquid crystal display device 1 is improved.

The display quality of the liquid crystal display device 1 can be further improved by not only applying voltages having different polarities to the adjacent first electrodes E1, but optimizing the shape of the light shielding layer 22. FIG. 10 is a plan view illustrating the shape of part of the light shielding layer 22 and a plurality of first electrodes E1. It also illustrates a scanning signal line G and an image signal line S. It, however, omits a switching element SW.

In the area illustrated in FIG. 10, the light shielding layer 22 includes a first portion 22A which extends in the second direction D2 between sub-pixels SP adjacent to each other in the first direction D1, and a second portion 22B which extends in the first direction D1 between sub-pixels SP adjacent to each other in the second direction D2. The first portion 22A, as seen in plan view, overlaps with the scanning signal line G and the switching element SW. The second portion 22B, as seen in plan view, overlaps with the image signal line S. The first portion 22A and the second portion 22B also overlap with the first electrodes E1.

The second portion 22B includes a first edge portion ED11 and a second edge portion DE12. These edge portions ED11 and ED12 are parallel to, for example, the first direction D1.

In the above area, the light shielding layer 22, in a second sub-pixel SP2, overlaps with a connection area 30. To be more specific, the first edge portion ED11 of the light shielding layer 22 is located between the bottom side 31 and the lateral side 32 of the connection area 30. Also, the light shielding layer 22, in a first sub-pixel SP1, overlaps with distal end portions of branch areas 40.

The width of part of the light shielding layer 22 at which the light shielding layer 22 overlaps with the connection area 30 in the second direction D2 is a first width W1. The width of part of the light shielding layer 22 at which the light shielding layer 22 overlaps with the distal end portions of the branch areas 40 in the second direction D2 is a second width W2. The vicinity of the branch areas 40 is an area to be made to contribute to displaying of an image. In order to increase an aperture ratio, it is better to set the second width W2 to a small value. By contrast, in the vicinity of the lateral side 32 of the connection area 30, when a voltage is applied to the first electrodes E1, alignment of liquid crystal molecules can become unstable. It is therefore better to set the first width W1 to a great value to block light. For such a reason, in the example illustrated in FIG. 10, the first width W1 is set greater than the second width W2 (W1>W2).

From another standpoint, center CT1 of the second portion 22B in the second direction D2 is closer to the second sub-pixel SP2 than center CT2 of the gap between the distal end portions of the branch areas 40 of the first sub-pixel SP1 and the connection area 30 of the second sub-pixel SP2. The center CT2 is coincident with, for example, the center of the image signal line S in the second direction D2.

Where an electric field is produced between a first electrode E1 and the second electrode E2, the brightness of light transmitted through the vicinity of the distal end portions of the branch areas 40 lowers as the distance between the position of the transmitted light and the distal end portions of the branch areas 40 increases. However, since the light shielding layer 22 overlaps with the branch areas 40 at the distal end portions thereof, it can shield from light an area the brightness of which varies as described above, and improve the contrast between the sub-pixels SP. It should be noted that the light shielding layer 22 does not always need to overlap with the distal end portions of the branch areas 40 (it may be set that W2=0). In this case, it is possible to increase the aperture ratio in each of the sub-pixels SP.

Such variation of the brightness as described above also occurs at the vicinity of proximal ends of the branch areas 40. In view of this point, in order to further increase the contrast, the first edge portion ED11 of the second portion 22B may be located in a position shifted from the connection area 30 toward the distal end portions of the branch areas 40 extending from the connection area 30. To be more specific, the first edge portion ED11 is located on, for example, a line L as indicated in FIG. 10. In this case, the light shielding layer 22 is located above the entire connection area 30.

Second portions 22B, of which the first sub-pixels SP1 are located leftward and the second sub-pixels SP2 are located rightward, all have the above structure. Also, second portions 22B, of which the first sub-pixels SP2 are located leftward and the first sub-pixels SP1 are located rightward, have the above structure.

In the following, P[μm] is a pitch at which the branch areas 40 are arranged in the first direction D1, and W[μm] is a distance between each of the branches areas 40 of one of two sub-pixels SP arranged in the second direction D2 and the connection area 30 of the other sub-pixel SP. By setting the distance W to a small value, the elements of the sub-pixels SP can be arranged at a higher density. However, in the case where the distance W is small, an electric field can be produced between adjacent first electrodes E1. Thus, alignment of liquid crystal molecules present at the distal end portions of the branch areas 40 becomes unstable. Also, the greater the pitch P, the more stable the alignment of liquid crystal molecules present between adjacent branch areas 40 becomes. That is, in the case where the pitch P is set great, even if the distance W is set small, the alignment is kept stable. For example, if the pitch P and the distance W are determined such that PW>8 [μm²], preferably PW>10 [μm²], the alignment can be made stable, and at the same time the elements of the sub-pixels can be arranged at a higher density.

In the example illustrated in FIG. 10, the distance between the distal end portion of each of the branch areas 40 of one of two first electrodes E1 adjacent to each other in the second direction D2 and the connection area 30 of the other first electrode E1 is the above shortest distance Dmin. That is, the shortest distance Dmin is equal to the width W. However, the shortest distance Dmin may be the distance between other areas, for example, the distance between the end area 50 of the first sub-pixel SP1 and the connection area 30 of the second sub-pixel SP2. In the example illustrated in FIG. 10, the pitch P is greater than the shortest distance Dmin and the distance W (P>Dmin and W). Furthermore, the distance between the branch areas 40 (for example, the length of the bottom side 31) is greater than the shortest distance Dmin and the width W. In such a manner, by setting the distance W and the shortest distance Dmin to a small value, the elements of the sub-pixels can be suitable arranged at a higher density.

As explained above, in the first embodiment, voltages having different polarities are applied to first electrodes E1 adjacent to each other in the second direction D2. As a result, alignment of liquid crystal molecules present in the vicinity of the boundary between the adjacent first electrodes E1 becomes stable, thus improving the display quality. Furthermore, the display quality can be further improved by designing the shape of the light shielding layer 22, etc., as described above.

In addition to this advantage, the first embodiment can obtain the above-mentioned advantages and other advantages.

### Second Embodiment

The second embodiment will be described as follows. The following explanation of the second embodiment refers mainly to the differences between the first and second embodiments, and appropriately omits the same structure as in the first embodiment.

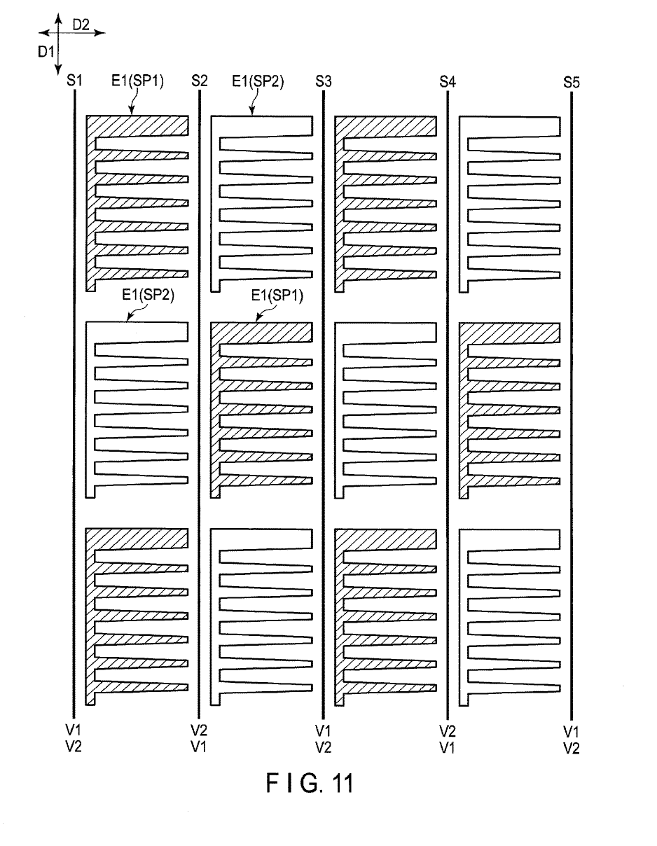

In the second embodiment, first sub-pixels SP1 and second sub-pixels SP2 are arranged in a manner different from that in the first embodiment. FIG. 11 is a plan view illustrating an example of arrangement of sub-pixels SP in the second embodiment. FIG. 11, as well as FIG. 8, illustrates image signal lines S1 to S5 and sub-pixels arranged between these image signal lines.

In the second embodiment, the second driver DR2 as illustrated in FIG. 2 switches voltages to be applied to image signal lines S between a first voltage V1 having a positive polarity and a second voltage V2 having a negative polarity each time a voltage is applied to a horizontal line. To be more specific, each of horizontal lines is a line of sub-pixels SP (i.e., a row of sub-pixels SP) which are arranged in the second direction D2 between associated adjacent scanning signal lines. Furthermore, in the second embodiment, voltages applied to adjacent image signal lines S at the above timing of applying a voltage to the horizontal line have opposite polarities.

In such a manner, when voltages are applied to the image signal lines S, as illustrated in FIG. 11, in both the first direction D1 and the second direction D2, first sub-pixels SP1 to which the first voltage V1 is to be applied and second sub-pixels SP2 to which the second voltage V2 is to be applied are alternately arranged. By virtue of this structure, not only alignment of liquid crystal molecules present in the vicinity of the boundaries between first electrodes E1 adjacent to each other in the second direction D2, but alignment of liquid crystal molecules present in the vicinity of the boundaries between first electrodes E1 adjacent to each other in the first direction D1 can be stabilized. Therefore, the display quality of the liquid crystal display device 1 can be further improved.

In addition, the third embodiment can also obtain the same advantages as the first embodiment.

### Third Embodiment

The third embodiment will be described as follows. The following explanation of the third embodiment refers mainly to the differences between the third embodiment and each of the first and second embodiments, and appropriately omits the same structure as in each of the first and second embodiments.

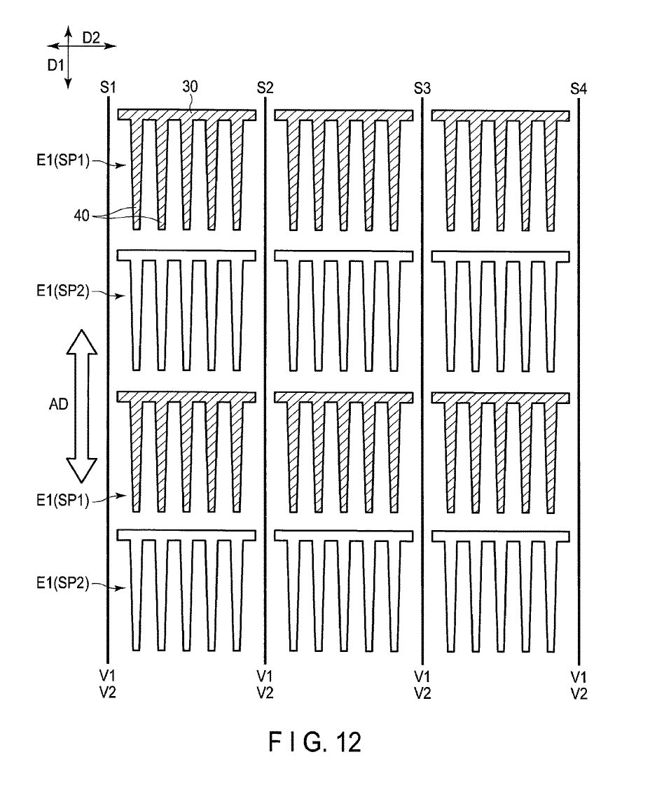

The third embodiment is different from the first and second embodiments in the shape of the first electrodes E1 and the arrangement of the first sub-pixels SP1 and second sub-pixels SP2. FIG. 12 is a plan view illustrating an example of arrangement of the sub-pixels SP in the third embodiment. FIG. 12 illustrates first electrodes E1 of sub-pixels SP arranged between image signal lines S1 to S4.

In the first electrodes E1 as illustrated in FIG. 12, connection areas 30 extend in the second direction D2, and from each of the connection areas 30, a plurality of branch areas 40 extend in the first direction D1. The alignment treatment direction AD of the first alignment film 13 and the second alignment film 24 is parallel to the first direction D1. In such a structure also, the high-speed response mode can be achieved.

In the third embodiment, since the branch areas 40 extend in the first direction D1, the voltages of first electrodes E1 adjacent to each other in the first direction D1 easily have an influence on the alignment of liquid crystal molecules present in the vicinity of the branch areas 40. In view of this point, voltages having different polarities are applied to the first electrodes E1 adjacent to each other in the first direction D1. To be more specific, the second driver DR2 as illustrated in FIG. 2 switches voltages to be applied to image signal lines S between the first voltage V1 having a positive polarity and the second voltage V2 having a negative polarity each time a voltage is applied to a horizontal line.

When voltages are applied to the image signal lines S in the above manner, as illustrated in FIG. 12, horizontal lines of first sub-pixels SP1 and horizontal lines of second sub-pixels SP2 are alternately arranged in the first direction D1. Thereby, it is possible to stabilize the alignment of liquid crystal molecules present in the vicinity of the boundaries between the first electrodes adjacent to each other in the first direction D1. In addition, the third embodiment can also obtain the same advantages as the first embodiment.

It should be noted that in the third embodiment also, it may be set that as in the second embodiment, voltages are applied to the image signal lines S such that in both the first direction D1 and the second direction D2, first sub-pixels SP1 and the second sub-pixels SP2 are alternately arranged. In this case, it is possible to stabilize not only the alignment of liquid crystal molecules present in the vicinity of the first electrodes adjacent to each other in the first direction D1, but the alignment of liquid crystal molecules present in the vicinity of first electrodes E1 adjacent to each other in the second direction D2.

### Fourth Embodiment

The fourth embodiment will be described as follows. The following explanation of the fourth embodiment refers mainly to the differences between the sixth embodiment and each of the first to third embodiments, and appropriately omits the same structure as in each of the first to third embodiments.

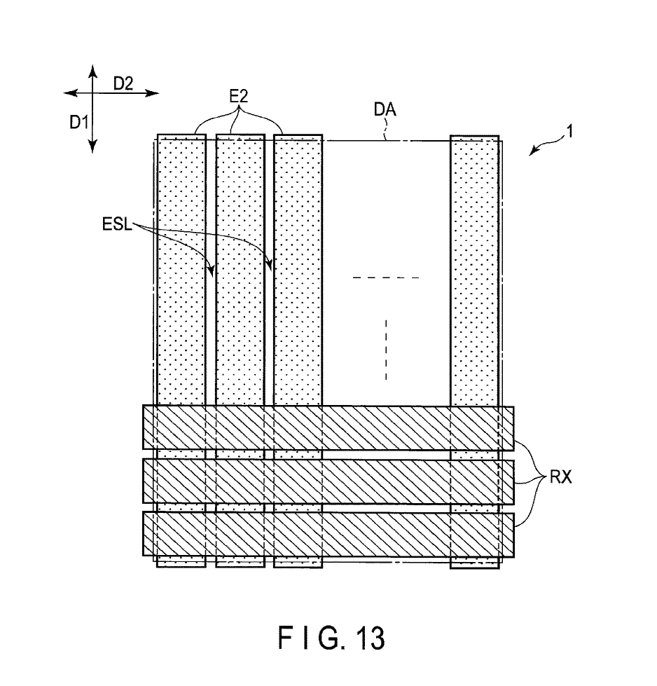

In the fourth embodiment, the liquid crystal display device 1 also has the function of a touch panel. In this regard, the fourth embodiment is different from the first to third embodiment. FIG. 13 is a plan view of part of a configuration of the liquid crystal display device 1 according to the fourth embodiment. In the display area DA, a plurality of second electrodes E2 functioning as common electrodes and a plurality of detection electrodes RX are arranged.

The second electrodes E2 extend in the first direction D1, and are arranged in the second direction D2. Between adjacent second electrodes E2, slits ESL are provided to extend in the first direction D1. The detection electrodes RX extend in the second direction D2, and are arranged in the first direction D1. In such a structure, it is possible to detect an object such as a finger, which is in proximity of the display area DA, based on a change which is made in capacitances between the second electrodes E2 and the detection electrodes RX.

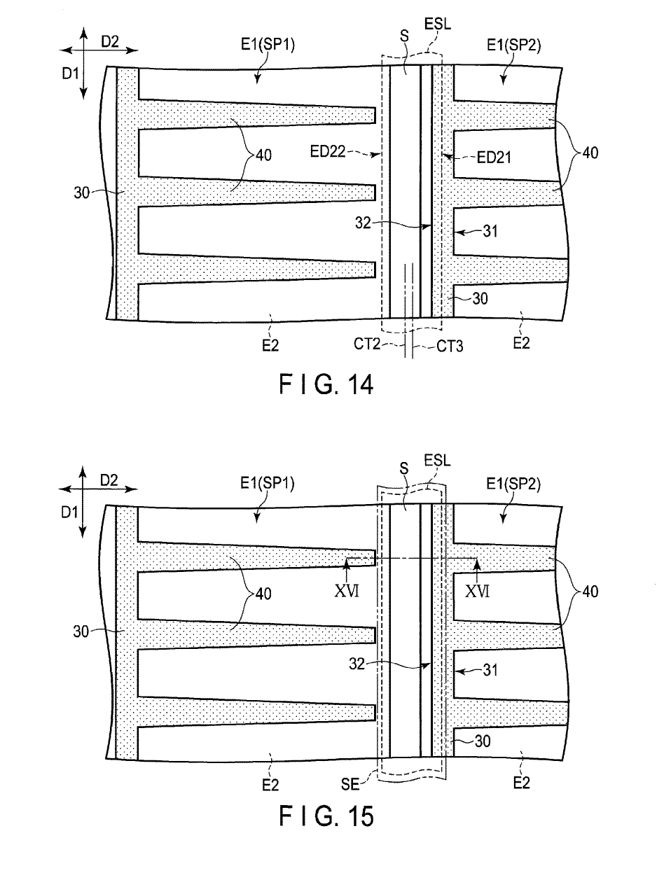

FIG. 14 is a plan view schematically illustrating a configuration of the vicinity of a slit ESL. FIG. 14 illustrates the slit ESL and two first electrodes E1 which are adjacent to each other, with an image signal lines interposed between them. The first electrodes E1 have the same shape as those of the first embodiment. For example, referring to FIG. 14, the left one of the two first electrodes E1 is the first electrode E1 of a first sub-pixel SP1, and the right one of the first electrodes E1 is the first electrode E1 of a second sub-pixel SP2. The slit ESL is provided in the boundary between a second electrode E2 (first common electrode) located opposite to the above left first electrode E1 and a second electrode E2 (second common electrode) located opposite to the above right first electrode E1.

The slit ESL overlaps with the image signal line S as seen in plan view. In the example illustrated in FIG. 14, center CT3 of the slit ESL in the second direction D2 is closer to the second sub-pixel SP2 than the center CT2 of the gap between the branch areas 40 of the first sub-pixel SP1 and the connection area 30 of the second sub-pixel SP2 in the second direction D2.

The slit ESL includes a first edge portion ED21 and a second edge portion ED22. The edge portions ED21 and ED22 are parallel to, for example, the first direction D1. The slit ESL, in the second sub-pixel SP2, overlaps with the connection area 30. To be more specific, the first edge portion ED21 is located between the bottom side 31 and lateral side 32 of the connection area 30. By contrast, the slit ESL, in the first sub-pixels SP1, does not overlap with the distal end portions of the branch area 40. Even in the case where the second sub-pixel SP2 is located on the left side, and the first sub-pixels SP1 is located on the right side, the slit ESL has the same structure as described above.

Since the vicinity of the lateral side 32 hardly contributes to displaying of an image, even if the slit ESL is provided to overlap with the connection area 30 as illustrated in FIG. 14, this structure does not influence the display quality. Furthermore, since the first edge portion ED21 is provided to overlap with the connection area 30, it is possible that the slit ESL is provided to have the greatest possible width, and the insulation between adjacent second electrodes E2 can be improved. Thereby, the accuracy of touch detection can be increased.

On the other hand, the distal end portions and proximal end portions of the branch areas 40 contribute to displaying of an image. Since these portions are located not to overlap the slit ESL, an electric field which rotates liquid crystal molecules is satisfactorily produced between the first electrode E1 and the second electrode E2. Thereby, the display quality is improved.

In addition, the fourth embodiment can also obtain the same advantages as the above embodiments.

It should be noted that in the above explanation of the fourth embodiment, the slits ESL provided between the adjacent second electrodes E2 are referred to; however, the same structure as described above with respect to the slits ESL can also be applied to dummy slits. The dummy slits are intended to increase the density of slits provided in, for example, the display area DA, and reduce the influence of the slits ESL upon displaying of an image. The dummy slits are provided at regular intervals in the second electrodes E2. Portions of each of the second electrodes E2, which are located on the both sides of an associated dummy slit, have the same potential, since they are continuous with each other and thus electrically connected to each other, for example, in a peripheral area located outward of the display area DA.

### Fifth Embodiment

The fifth embodiment will be described as follows. The following explanation of the fifth embodiment refers mainly to the differences between the fifth embodiment and each of the first to fourth embodiments, and appropriately omits the same structure as in each of the first to fourth embodiments.

The liquid crystal display device 1 according to the fifth embodiment has a further improved structure in addition to the structural features of the fourth embodiment. FIG. 15 is a plan view schematically illustrating the configuration of the vicinity of a slit ESL in the liquid crystal display device 1 according to the fifth embodiment. In the configuration illustrated in FIG. 15, a shield electrode SE is provided. In this regard, it is different from the configuration illustrated in FIG. 14.

The shield electrode SE extends in the first direction D1, and overlaps with the slit ESL as seen in plan view. The shield electrode SE, as well as the slit ESL, overlaps with the connection area 30, but does not overlap with the branch areas 40. The shield electrode SE is provided in a third layer, not the first layer in which the first electrode E1 is formed or the second layer in which the second electrode E2 is formed.

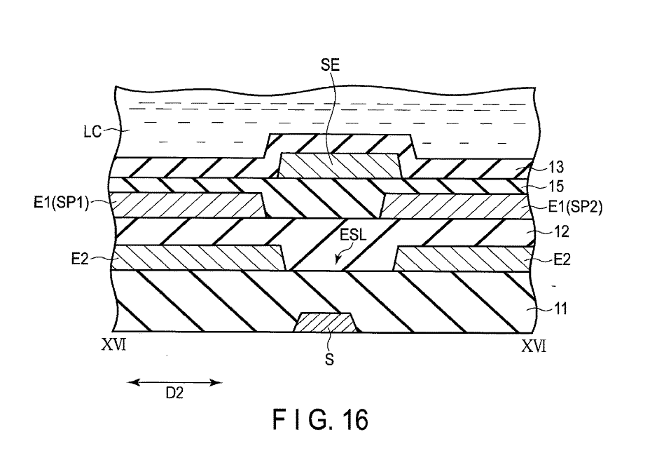

FIG. 16 is a schematic cross-sectional view taken along line XVI-XVI in FIG. 15. In the example illustrated in FIG. 16, first electrodes E1 are covered by a third insulating layer 15. The shield electrode SE is provided on the third insulating layer 15 (the above third layer). The first alignment film 13 covers the third insulating layer 15 and the shield electrode SE.

The shield electrode SE, as well as, for example, the electrodes E1 and E2, is formed of a transparent conductive material such as ITO or IZO. Although the potential of the shield electrode SE is arbitrary, a common voltage is applied to the shield electrode SE as in, for example, the second electrode E2.

Because of provision of the slit ESL, an electric field is produced between the first electrode E1 and the image signal line S, and can act on the liquid crystal layer LC. However, the shield electrode SE can prevent the electric field from reaching the liquid crystal layer LC, and thus further improve the display quality.

In addition, the fifth embodiment can also obtain the same advantages as the above embodiments.

### Sixth Embodiment

The sixth embodiment will be described as follows. The following explanation of the sixth embodiment refers mainly to the differences between the sixth embodiment and each of the first to fifth embodiments, and appropriately omits the same structure as in each of the first to fifth embodiments.

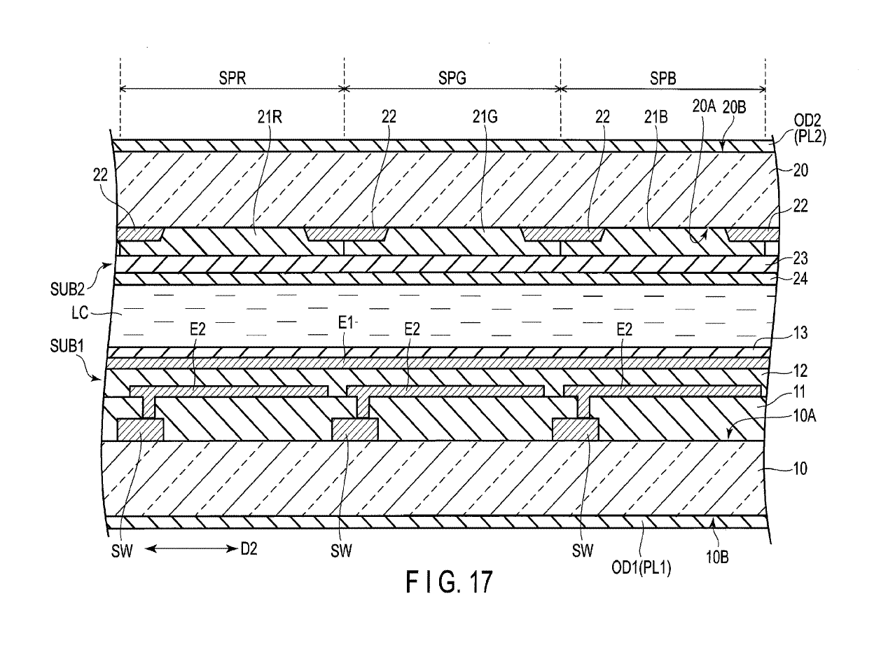

In the sixth embodiment, a first electrode E1 is a common electrode, and second electrodes E2 are pixel electrodes. In this regard, the sixth embodiment is different from the first to fifth embodiments. FIG. 17 is a view illustrating part of a cross section of the liquid crystal display device 1 according to the sixth embodiment. To be more specific, FIG. 17, as well as FIG. 3, illustrates a cross section of each of sub-pixels SPR, SPG and SPB, which is taken along the second direction D2. Also, FIG. 17 omits the scanning signal lines G and the image signal lines S, and simplifies the switching elements SW.

Referring to FIG. 17, the first electrode E1 is provided to extend in all the sub-pixels SPR, SPG and SPB. On the other hand, the second electrodes E2 are respectively provided in the sub-pixels SPR, SPG and SPB. Each of the second electrodes E2 is electrically connected to an associated one of the switching elements SW.

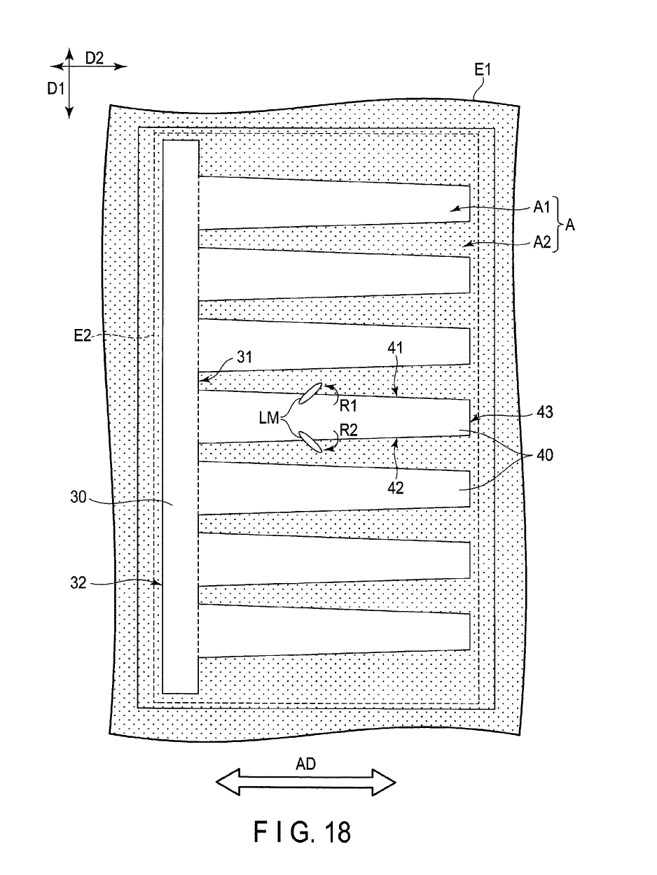

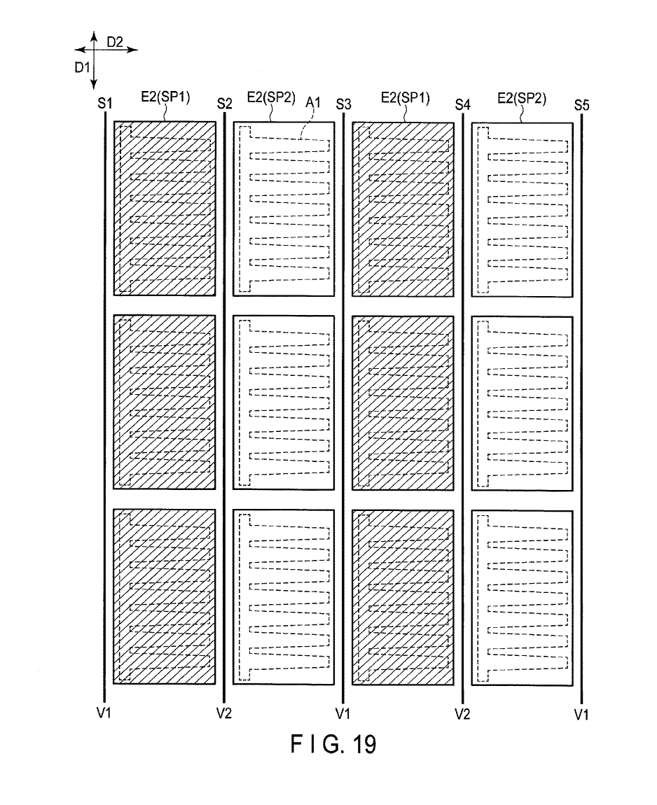

FIG. 18 is a schematic plan view of the first electrode E1. FIG. 18 primarily illustrates an area corresponding to a single sub-pixel SP. In the example illustrated in FIG. 18, the sub-pixel area A includes a first area A1 and a second area A2 as in the example illustrated in FIG. 4. Furthermore, the first area A1 includes a connection area 30 and branch areas 40. In the sixth embodiment, the second area A2 is provided in the first electrode E1, and the first area A1 is not provided in the first electrode E1. That is, the first area A1 is a slit (opening) including the connection area 30 and the branch areas 40. Each of the second electrodes E2 is formed in the shape of, for example, a frame indicated by a broken line, and located within the first area A1 as seen in plan view.

The connection area 30 and the branch areas 40 have substantially the same shapes as those of the example of FIG. 4. However, referring to FIG. 18, the width of each of the branch areas 40 in the first direction D1 is greater than that of the example of FIG. 4. For example, in the example of FIG. 4, the width of part of each of the branch areas 40 which is close to the distal end portion thereof is smaller than the distance between any adjacent two of the branch areas 40. By contrast, in the example of FIG. 18, the width of part of each of the branch areas 40 which is close to the distal end portion thereof is greater than the distance between any adjacent two of the branch areas 40.

When an electric field is produced between the first electrode E1 and the second electrode E2, liquid crystal molecules LM present in the vicinity of the first sides 41 and second sides 42 of the branch areas 40 are rotated as in the example of FIG. 6. To be more specific, in the vicinity of the first sides 41, liquid crystal molecules LM present in the range from the bottom sides 31 to the distal sides 43 are rotated in the first rotational direction R1. In the vicinity of the second sides 42, liquid crystal molecules LM present in the range from the bottom sides 31 to the distal sides 43 are rotated in the second rotational direction R2. In such a manner, the sixth embodiment can also obtain the same advantages as the above embodiments.

In the structure according to the sixth embodiment also, when voltages having the same polarity are applied to adjacent pixel electrodes, i.e., adjacent second electrode E2, the alignment of liquid crystal molecules present in the vicinity of the boundary between these second electrodes E2 can become unstable. Also, in the sixth embodiment, by applying thereto the method explained above with respect to FIG. 8 or 11, it is possible to stabilize the alignment of liquid crystal molecules present in the vicinity of the boundary between the second electrodes E2.

An example of application of the same method as described with reference to FIG. 8 is illustrated in FIG. 19. Columns of first sub-pixels SP1 arranged in the first direction D1 and columns of second sub-pixels SP2 arranged in the first direction D1 are alternately arranged in the second direction D2. In this example, the first sub-pixels SP1 are sub-pixels SP including second electrodes E2 to which the first voltage V1 is to be applied. The second sub-pixels SP2 are sub-pixels SP including second electrodes E2 to which the second voltage V2 is to be applied.

It should be noted that the configuration explained above with reference to FIG. 10 can be applied to the connection area 30, the branch areas 40 and the light shielding layer 22. Furthermore, as the shapes of the first areas A1 and the arrangement of the sub-pixels SP1 and SP2, those as illustrated in FIG. 12 can also be applied. Also, the configurations explained above with reference to FIGS. 13 to 16 can be applied. In this case, in the sixth embodiment, slits ESL are provided in the first electrode E1, which is a common electrode.

By virtue of the above structural features, the sixth embodiment can also obtain the same advantages as the above embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For examples, in the examples illustrated in FIGS. 8 and 19, columns of sub-pixels SP1 and columns of sub-pixels SP2 are alternately arranged, and in the example illustrated in FIG. 12, horizontal lines of first sub-pixels SP1 (i.e., rows of first sub-pixels SP1) and horizontal lines of second sub-pixels SP2 (i.e., rows of second sub-pixels SP2) are alternately arranged. However, it may be set that columns of first sub-pixels SP1 and columns of second sub-pixels SP2 alternate in units of n (n≧2) columns; that is, n (n≧2) columns of first sub-pixels SP1 are successively arranged in the second direction D2, and then n (n≧2) columns of second sub-pixels SP2 are successively arranged in the second direction D2, and this pattern of arrangement is repeated. Alternately, it may be set that horizontal lines of first sub-pixels SP1 and horizontal lines of second sub-pixels SP2 alternate in units of m (m≧2) horizontal lines; that is, m (m≧2) horizontal lines of first sub-pixels SP1 are successively arranged in the first direction D1, and then m (m≧2) horizontal lines of second sub-pixels SP2 are successively arranged in the first direction D1, and this pattern of arrangement is repeated.

Furthermore, the first sub-pixels SP1 and the second sub-pixels SP2 may be arranged in such a way as to alternate in units of one block consisting of n×m sub-pixels SP. In this case, for example, blocks each consisting of first sub-pixels SP1 and blocks each consisting of second sub-pixels SP2 may be alternately arranged in the first direction D1 and the second direction D2.

The shapes of the first areas A1 described by way of example with respect to the above embodiments can be modified as appropriate. For example, in each of the first areas A1, the extension direction of the connection area 30 and that of the branch areas 40 may cross each other at an angle other than a right angle. Furthermore, it may be set that each first area A1 includes a plurality of connection areas 30 connected to each other, and from each of the connection areas 30, branch areas 40 extend.

With respect to each of the above embodiments, a configuration which can be adopted in the case where the dielectric anisotropy of liquid crystal molecules of the liquid crystal layer LC is positive is explained above by way of example. However, the liquid crystal layer LC can also be formed to contain liquid crystal molecules having a negative dielectric anisotropy. In this case, it suffices that the alignment treatment direction AD (or the initial alignment direction of the liquid crystal molecules) is set perpendicular to the extension direction of the branch areas 40.

What is claimed is:

1. A liquid crystal display device comprising:
a liquid crystal layer including liquid crystal molecules between a first substrate and a second substrate facing the first substrate, wherein:
the first substrate comprises;
a plurality of image signal lines;
a plurality of scanning signal lines crossing the image signal lines;
pixel electrodes electrically connected to the image signal lines;
a common electrode configured to cause an electric field with the pixel electrodes to rotate the liquid crystal molecules; and
a plurality of sub-pixel areas,
the sub-pixel areas each have a first area and a second area in plan view;
the first area is an area in which an associated one of the pixel electrodes is provided, and the second area is an area in which the associated pixel electrode is not provided;
the first area includes a connection area extending in a first direction and a plurality of branch areas extending from the connection area in a second direction crossing the first direction;
the branch areas each include a first side and a second side in a width direction, and when the electric field is generated, liquid crystal molecules present in vicinity of the first side and liquid crystal molecules present in vicinity of the second side are rotated in different rotational directions;
the sub-pixel areas include first sub-pixel areas and second sub-pixel areas, and each of the first sub-pixel areas are adjacent to an associated one of the second sub-pixel areas, with an associated one of the image signal lines or the scanning signal lines interposed between the each first sub-pixel area and the associated second sub-pixel area;
a shortest distance between the first area of the each first sub-pixel area and the first area of the associated second sub-pixel area is 5 μm or less; and
when an image is displayed, a polarity of the pixel electrodes in the first sub-pixel areas is different from a polarity of the pixel electrodes in the second sub-pixel areas.

2. The liquid crystal display device of claim 1, wherein:
the branch areas included in each of the sub-pixel areas are arranged in the first direction;
the formula PW>8 [μm] is satisfied, where P [μm] is a pitch at which the branch areas are arranged in the first direction, and W [μm] is a distance between the branch areas of one of the each first sub-pixel area and the associated second sub-pixel area and the connection area of the other.

3. The liquid crystal display device of claim 1, wherein a distance between adjacent two of those branch areas of the branch areas which are provided in the first sub-pixel areas is greater than the shortest distance.

4. The liquid crystal display device of claim 1, wherein when the electric field is not generated, and the liquid crystal molecules are in an initial alignment state, major axes of the liquid crystal molecules are located in parallel to the second direction.

5. The liquid crystal display device of claim 1, wherein:
the image signal lines include a first image signal line, a second image signal line adjacent to the first image signal, and a third image signal line adjacent to the second image signal line;
the sub-pixel areas located between the first image signal line and the second image signal line are the first sub-pixel areas; and
the sub-pixel areas located between the second image signal line and the third image signal line are the second sub-pixel area.

6. The liquid crystal display device of claim 1, further comprising a light-shielding layer which is formed between the first sub-pixel areas and the second sub-pixel areas in plan view,
wherein the each first sub-pixel area and the associated second sub-pixel area are arranged in the second direction, and
a center of the light-shielding layer in the second direction is closer to the associated second sub-pixel area than a center of a gap in the second direction between distal end portions of the branch portions of the first sub-pixel area and the connection area of the associated second sub-pixel area.

7. The liquid crystal display device of claim 1, further comprising a light-shielding layer which is formed between the first sub-pixel areas and the second sub-pixel areas in plan view,
wherein the each first sub-pixel area and the associated second sub-pixel area are arranged in the second direction, and
the light-shielding layer overlaps with distal end portions of the branch portions provided in the first sub-pixel areas, in plan view.

8. The liquid crystal display device of claim 1, further comprising a light-shielding layer which is formed between the first sub-pixel areas and the second sub-pixel areas in plan view,
wherein the each first sub-pixel area and the associated second sub-pixel area are arranged in the second direction, and
in the second sub-pixel area, an edge portion of the light-shielding layer is located closer to distal end portions of the branch portions than the connection area.

9. The liquid crystal display device of claim 1, further comprising a light-shielding layer which is formed between the first sub-pixel areas and the second sub-pixel areas in plan view,
wherein the each first sub-pixel area and the associated second sub-pixel area are arranged in the second direction, and
the light-shielding layer overlaps with distal end portions of the branch portions located in the first sub-pixel area and at least part of the connection area provided in the second sub-pixel area, in plan view; and
a first distance by which the light-shielding layer overlaps with the connection area located in the second sub-pixel area in the second direction is greater than a second distance by which the light-shielding layer overlaps with the distal end portions of the branch portions located in the first sub-pixel area in the second direction.

10. The liquid crystal display device of claim 1, further comprising a shield layer which is formed in a third layer different from a first layer in which the pixel electrodes are formed and a second layer in which the common electrode is formed;
wherein the common electrode includes a first common electrode facing the pixel electrode provided in the first sub-pixel area and a second common electrode facing the pixel electrode provided in the second sub-pixel area;
in plan view, a slit is formed between the first common electrode and the second common electrode; and
in plan view, the shield electrode overlaps with the slit.

11. A liquid crystal display device comprising:
a liquid crystal layer including liquid crystal molecules between a first substrate and a second substrate facing the first substrate, wherein:
the first substrate comprises;
a plurality of image signal lines;
a plurality of scanning signal lines crossing the image signal lines;
pixel electrodes electrically connected to the image signal lines;
a common electrode configured to cause an electric field with the pixel electrodes to rotate the liquid crystal molecules; and
a plurality of sub-pixel areas,
the sub-pixel areas each have a first area and a second area in plan view;
the second area is an area in which the common electrode is provided, and the first area is an area in which the common electrode is not provided;
the first area includes a connection area extending in a first direction and a plurality of branch areas extending from the connection area in a second direction crossing the first direction;
the branch areas each include a first side and a second side in a width direction, and when the electric field is generated, liquid crystal molecules present in vicinity of the first side and liquid crystal molecules present in vicinity of the second side are rotated in different rotational directions;
the sub-pixel areas include first sub-pixel areas and second sub-pixel areas, and each of the first sub-pixel areas are adjacent to an associated one of the second sub-pixel areas, with an associated one of the image signal lines or the scanning signal lines interposed between the each first sub-pixel area and the associated second sub-pixel area;
a shortest distance between the first area of the each first sub-pixel area and the first area of the associated second sub-pixel area is 5 μm or less; and
when an image is displayed, a polarity of the pixel electrodes in the first sub-pixel areas is different from a polarity of the pixel electrodes in the second sub-pixel areas.

12. The liquid crystal display device of claim 11, wherein:
the branch areas included in each of the sub-pixel areas are arranged in the first direction;
the formula PW>8 [μm²] is satisfied, where P [μm] is a pitch at which the branch areas are arranged in the first direction, and W [μm] is a distance between the branch areas of one of the each first sub-pixel area and the associated second sub-pixel area and the connection area of the other.

13. The liquid crystal display device of claim 11, wherein a distance between adjacent two of the branch areas provided in the first sub-pixel areas is greater than the shortest distance.

14. The liquid crystal display device of claim 11, wherein when the electric field is not generated, and the liquid crystal molecules are in an initial alignment state, major axes of the liquid crystal molecules are located in parallel to the second direction.

15. The liquid crystal display device of claim 11, wherein:
the image signal lines include a first image signal line, a second image signal line adjacent to the first image signal, and a third image signal line adjacent to the second image signal line;
the sub-pixel areas located between the first image signal line and the second image signal line are the first sub-pixel areas; and
the sub-pixel areas located between the second image signal line and the third image signal line are the second sub-pixel area.

16. The liquid crystal display device of claim 11, further comprising a light-shielding layer which is formed between the first sub-pixel areas and the second sub-pixel areas in plan view,
wherein the each first sub-pixel area and the associated second sub-pixel area are arranged in the second direction, and
a center of the light-shielding layer in the second direction is closer to the associated second sub-pixel area than a center of a gap in the second direction between distal end portions of the branch portions of the first sub-pixel area and the connection area of the associated second sub-pixel area.

17. The liquid crystal display device of claim 11, further comprising a light-shielding layer which is formed between the first sub-pixel areas and the second sub-pixel areas in plan view,
wherein the each first sub-pixel area and the associated second sub-pixel area are arranged in the second direction, and
the light-shielding layer overlaps with distal end portions of the branch portions provided in the first sub-pixel areas, in plan view.

18. The liquid crystal display device of claim 11, further comprising a light-shielding layer which is formed between the first sub-pixel areas and the second sub-pixel areas in plan view,
wherein the each first sub-pixel area and the associated second sub-pixel area are arranged in the second direction, and
in the second sub-pixel area, an edge portion of the light-shielding layer is located closer to distal end portions of the branch portions than the connection area.

19. The liquid crystal display device of claim 11, further comprising a light-shielding layer which is formed between the first sub-pixel areas and the second sub-pixel areas in plan view,
wherein the each first sub-pixel area and the associated second sub-pixel area are arranged in the second direction, and
the light-shielding layer overlaps with distal end portions of the branch portions located in the first sub-pixel area and at least part of the connection area located in the second sub-pixel area, in plan view; and
a first distance by which the light-shielding layer overlaps with the connection area located in the second sub-pixel area in the second direction is greater than a second distance by which the light-shielding layer overlaps with the distal end portions of the branch portions located in the first sub-pixel area in the second direction.

20. The liquid crystal display device of claim 11, further comprising a shield layer which is formed in a third layer different from a first layer in which the pixel electrodes are formed and a second layer in which the common electrode is formed;
wherein the common electrode includes a first common electrode facing the pixel electrode provided in the first sub-pixel area and a second common electrode facing the pixel electrode provided in the second sub-pixel area;
in plan view, a slit is formed between the first common electrode and the second common electrode; and
in plan view, the shield electrode overlaps with the slit.
